(19) United States
(12) Patent Application Publication
(10) Pub. No.: US 2014/0292284 A1
(43) Pub. Date: Oct. 2, 2014

(54) ELECTRICAL CAPACITOR, ELECTRICAL CAPACITOR MODULE, FABRICATION METHOD OF THE ELECTRICAL CAPACITOR, AND FABRICATION METHOD OF THE ELECTRICAL CAPACITOR MODULE

(71) Applicant: ROHM CO., LTD., Kyoto (JP)

(72) Inventor: Hideki SAWADA, Kyoto (JP)

(73) Assignee: ROHM CO., LTD., Kyoto (JP)

(21) Appl. No.: 14/224,784

(22) Filed: Mar. 25, 2014

(30) Foreign Application Priority Data
Mar. 26, 2013 (JP) 2013-063292
May 27, 2013 (JP) 2013-110919

(51) Int. Cl. H01G 11/26; H01G 13/00; H01M 10/0525; H02J 7/00; H01M 10/0587

(52) U.S. Cl. CPC H01G 11/26; H02J 7/00; H01M 10/0587; H01M 10/0525; H01G 13/00
USPC 320/167; 361/500; 361/502; 361/752; 429/94; 156/192; 156/73.1

(57) ABSTRACT

An electrical capacitor includes: a band-shaped coating foil for positive electrode having a non-coated part of which an edge of one longitudinal side is not coated with an active material; a band-shaped coating foil for negative electrode having a non-coated part of which an edge of one longitudinal side is not coated with an active material; and a band-shaped separators through which an electrolysis solution and ions can pass. The coating foil for positive electrode and the coating foil for negative electrode are flatly wound via the separators so that the non-coated part in the side of the coating foil for positive electrode and the non-coated part in the side of the coating foil for negative electrode are exposed in opposite sides to each other, and the electrode group of the non-coated parts exposed to both sides are bonded.

### CROSS REFERENCE TO RELATED APPLICATIONS AND INCORPORATION BY REFERENCE

This application is based upon and claims the benefit of priority from prior Japanese Patent Application Nos. P2013-63292 filed on Mar. 26, 2013, and P2013-110919 filed on May 27, 2013, the entire contents of which are incorporated herein by reference.

### TECHNICAL FIELD

The present invention relates to an electrical capacitor, an electrical capacitor module, a fabrication method of such an electrical capacitor, and a fabrication method of such an electrical capacitor module.

### BACKGROUND ART

In recent years, electric double-layered capacitors, lithium ion capacitors, etc. have received attention as electrical capacitors capable of rapid charging and discharging and achieving a long life (e.g., refer to Patent Literatures 1 and 2). Structures of this kind of electrical capacitors are roughly classified into a wound type structure and a laminated type structure. The wound type electrical capacitor has both of stable features and efficient productivity since the electrodes can be efficiently opposed to each other. On the other hand, the laminated type electrical capacitor is characterized to be thin and have a low internal electrical resistance since it has structure of laminating plate-shaped electrodes.

### CITATION LIST

Patent Literature 1: Japanese Patent Application Laying-Open Publication No. 2010-161249
Patent Literature 2: Japanese Patent Application Laying-Open Publication No. 2011-199107

### SUMMARY OF THE INVENTION

### Technical Problem

However, the internal electrical resistance of the wound type electrical capacitor increases since it has a structure of connecting external terminals to edge parts of cylindrical electrode group to achieving current collection. On the other hand, in order to obtain the high-capacity laminated electrical capacitor, it is necessary to enlarge the area or to increase the number of sheets thereof.

The object of the present invention is to provide an electrical capacitor and an electrical capacitor module both of which have low internal electrical resistance and are easy to increase in capacity; and to provide a fabrication method of such an electrical capacitor, and a fabrication method of such an electrical capacitor module.

### Solution to Problem

According to one aspect of the present invention, there is provided an electrical capacitor comprising: a band-shaped coating foil for negative electrode having a non-coated part of which an edge of one longitudinal side is not coated with an active material; a band-shaped coating foil for negative electrode having a non-coated part of which an edge of one longitudinal side is not coated with an active material; and a band-shaped separators through which an electrolysis solution and ions can pass, wherein the coating foil for positive electrode and the coating foil for negative electrode are flatly wound via the separators so that the non-coated part in the side of the coating foil for positive electrode and the non-coated part in the side of the coating foil for negative electrode are exposed in opposite sides to each other, and the electrode group of the non-coated parts exposed to both sides are bonded.

Moreover, according to another aspect of the present invention, there is provided an electrical capacitor module, wherein the electrical capacitor is housed in a box-typed case, and the electrode tabs or the lead terminals is connected to the PCB substrate.

Moreover, according to still another aspect of the present invention, there is provided a fabrication method of an electrical capacitor comprising: coating an active material other than an edge of one longitudinal side of a band-shaped coating foil for positive electrode; coating the active material other than an edge of one longitudinal side of a band-shaped coating foil for negative electrode; laminating the coating foil for positive electrode and the coating foil for negative electrode via separators so that a non-coated part in the side of the coating foil for positive electrode and a non-coated part in the side of the coating foil for negative electrode are exposed in opposite sides to each other; flatly winding a laminated electrode group; and bonding the electrode group of the non-coated parts wound to be exposed to both sides.

Moreover, according to yet another aspect of the present invention, there is provided a fabrication method of the electrical capacitor module wherein the electrical capacitor is housed in a box-typed case, and the electrode tabs or the lead terminals is connected to the PCB substrate.

### Advantageous Effects of Invention

According to the present invention, there can be provided the electrical capacitor and the electrical capacitor module both of which have low internal electrical resistance and are easy to increase in capacity; and can be provided the fabrication method of such an electrical capacitor, and the fabrication method of such an electrical capacitor module.

### BRIEF DESCRIPTION OF DRAWINGS

FIG. 1A is a diagram for explaining an electrical capacitor according to an embodiment, which is a schematic bird's-eye view configuration diagram showing the electrical capacitor according to the embodiment.

FIG. 1B is a diagram for explaining the electrical capacitor according to the embodiment, which is a schematic side configuration diagram showing the electrical capacitor shown in FIG. 1A.

FIG. 1C is a diagram for explaining the electrical capacitor according to the embodiment, which is a schematic side configuration diagram showing a state of bonding non-coated parts of a group of the electrodes in the electrical capacitor shown in FIG. 1A.

FIG. 2A is a diagram for explaining a wound type electrical capacitor according to a comparative example, which is a schematic plane configuration diagram showing a state before winding.

FIG. 2B is a diagram for explaining a wound type electrical capacitor according to a comparative example, which is a schematic bird's-eye view configuration diagram showing a state during winding.

FIG. 3A is a photograph of an example of the wound type electrical capacitor shown in FIGS. 2A and 2B, which is the photograph example for explaining a front side surface of a coating foil for a positive electrode to which an electrode tab is bonded with caulking.

FIG. 3B is a photograph of the example of the wound type electrical capacitor shown in FIGS. 2A and 2B, which is the photograph example for explaining a back side surface of the coating foil for the positive electrode to which the electrode tab is bonded with caulking.

FIG. 3C is a photograph of the example of the wound type electrical capacitor shown in FIGS. 2A and 2B, which is the photograph example for explaining the electrical capacitor.

FIG. 4 is a schematic plane configuration diagram showing bonded parts in another wound type electrical capacitor according to the comparative example.

FIG. 5 is a schematic bird's-eye view configuration diagram showing a state where electrode tabs with lead are bonded to the coating foil with caulking, in a fabrication method of the electrical capacitor module according to the comparative example.

FIG. 6 is a schematic bird's-eye view configuration diagram showing an aspect that the coating foils are cylindrically wound, in the fabrication method of the electrical capacitor module according to the comparative example.

FIG. 7A is a schematic bird's-eye view configuration diagram showing the cylindrical electrical capacitor from which the electrode tab with lead is projected, in the fabrication method of the electrical capacitor module according to the comparative example.

FIG. 7B is a schematic cross-sectional configuration diagram showing a cylindrical electrical capacitor module in which the electrical capacitor is housed, in the fabrication method of the electrical capacitor module according to the comparative example.

FIG. 8A is a schematic bird's-eye view configuration diagram showing the cylindrical electrical capacitor from which a plate electrode tab is projected, in the fabrication method of the electrical capacitor module according to the comparative example.

FIG. 8B is a schematic cross-sectional configuration diagram showing a cylindrical electrical capacitor module in which the electrical capacitor is housed, in the fabrication method of the electrical capacitor module according to the comparative example.

FIG. 9A is a process chart showing a step of coating an active material, in a fabrication method of the electrical capacitor according to the embodiment.

FIG. 9B is a process chart showing a step of laminating an electrode group, in the fabrication method of the electrical capacitor according to the embodiment.

FIG. 9C is a process chart showing a step of winding the electrode group, in the fabrication method of the electrical capacitor according to the embodiment.

FIG. 9D is a process chart showing a step of fixing the wound electrode group, in the fabrication method of the electrical capacitor according to the embodiment.

FIG. 9E is a process chart showing a step of bonding the electrode group of non-coated parts with electrode tabs, in the fabrication method of the electrical capacitor according to the embodiment.

FIG. 9F is a process chart showing a step of covering the electrode group with a laminate sheet, in the fabrication method of the electrical capacitor according to the embodiment.

FIG. 10 is a schematic bird's-eye view configuration diagram showing a winding device used for the fabrication of the electrical capacitor according to the embodiment.

FIG. 11A is a diagram for explaining an aspect that the electrode tab is bonded in the electrical capacitor according to the embodiment, which is a schematic plane configuration diagram showing a state before the bonding.

FIG. 11B is a diagram for explaining an aspect that the electrode tab is bonded in the electrical capacitor according to the embodiment, which is a schematic plane configuration diagram showing a state after the bonding.

FIG. 12 is a schematic side configuration diagram showing an aspect that the electrode group of non-coated parts shown in FIGS. 11A and 11B are bonded with ultrasonic welding.

FIG. 13 is a schematic plane configuration diagram showing bonded parts in the electrical capacitor according to the comparative example.

FIG. 14 is a schematic plane configuration diagram showing bonded parts in the electrical capacitor according to the embodiment.

FIG. 15 is a schematic plane configuration diagram showing alternative bonded parts in the electrical capacitor according to the embodiment.

FIG. 16 is a schematic plane configuration diagram showing a modified example 1 of bonding positions of the electrode tabs in the electrical capacitor according to the embodiment.

FIG. 17 is a schematic plane configuration diagram showing a modified example 2 of bonding positions of the electrode tabs in the electrical capacitor according to the embodiment.

FIG. 18 is a schematic plane configuration diagram showing a modified example 3 of bonding positions of the electrode tabs in the electrical capacitor according to the embodiment.

FIG. 19 is a schematic bird's-eye view configuration diagram showing an aspect of flatly winding, in a fabrication method of the electrical capacitor module according to the embodiment.

FIG. 20A is a schematic plane configuration diagram showing a state where pin-shaped lead terminals are bonded thereto, in the fabrication method of the electrical capacitor module according to the embodiment.

FIG. 20B is a schematic side configuration diagram showing a state where pin-shaped lead terminals are bonded thereto, in the fabrication method of the electrical capacitor module according to the embodiment.

FIG. 21A is a schematic plane configuration diagram showing a state where the electrode group shown in FIG. 20A and FIG. 20B is covered with a laminate sheet and then reinforced with resin, in the fabrication method of the electrical capacitor module according to the embodiment.

FIG. 21B is a schematic side configuration diagram showing a state where the electrode group shown in FIG. 20A and FIG. 20B is covered with a laminate sheet and then reinforced with resin, in the fabrication method of the electrical capacitor module according to the embodiment.

FIG. 22 is a schematic plane configuration diagram showing the electrical capacitor in which the pin-shaped lead terminals are projected to the outside of the laminate sheet, in the fabrication method of the electrical capacitor module according to the embodiment.

FIG. 23A is a schematic bird's-eye view configuration diagram showing a state before housing the electrical capacitor, in the fabrication method of the electrical capacitor module according to the embodiment.

FIG. 23B is a schematic bird's-eye view configuration diagram showing a state after housing the electrical capacitor, in the fabrication method of the electrical capacitor module according to the embodiment.

FIG. 24A is a schematic plane configuration diagram showing a state where the electrode tabs are bonded thereto, in the fabrication method of the electrical capacitor module according to the embodiment.

FIG. 24B is a schematic side configuration diagram showing a state where the electrode tabs are bonded thereto, in the fabrication method of the electrical capacitor module according to the embodiment.

FIG. 25A is a schematic plane configuration diagram showing a state where the electrode group shown in FIG. 24A and FIG. 24B is covered with a laminate sheet, in the fabrication method of the electrical capacitor module according to the embodiment.

FIG. 25B is a schematic side configuration diagram showing a state where the electrode group shown in FIG. 24A and FIG. 24B is covered with a laminate sheet, in the fabrication method of the electrical capacitor module according to the embodiment.

FIG. 26 is a schematic plane configuration diagram showing the electrical capacitor in which the plate-shaped electrode tabs are projected to the outside of the laminate sheet, in the fabrication method of a modified example of the electrical capacitor module according to the embodiment.

FIG. 27A is a schematic bird's-eye view configuration diagram showing a state before housing the electrical capacitor, in the fabrication method of the modified example of the electrical capacitor module according to the embodiment.

FIG. 27B is a schematic bird's-eye view configuration diagram showing a state after housing the electrical capacitor, in the fabrication method of the modified example of the electrical capacitor module according to the embodiment.

FIG. 28 is a schematic cross-sectional structure diagram taken in the line I-I of FIG. 27B.

FIG. 29 is a schematic circuit block configuration diagram showing a voltage balance control circuit included in the electrical capacitor module according to the embodiment.

FIG. 30 is a detailed schematic circuit block configuration diagram showing the voltage balance control circuit included in the electrical capacitor module according to the embodiment.

FIG. 31 is a schematic planar pattern configuration diagram illustrating a fundamental structure of an electric double-layer capacitor (EDLC) internal electrode, in the electrical capacitor according to the embodiment.

FIG. 32 is a schematic planar pattern configuration diagram illustrating a fundamental structure of a lithium ion capacitor internal electrode, in the electrical capacitor according to the embodiment.

FIG. 33 is a schematic planar pattern configuration diagram illustrating a fundamental structure of a lithium ion battery internal electrode, in the electrical capacitor according to the embodiment.

### DESCRIPTION OF EMBODIMENTS

There will be described embodiments of the present invention, with reference to the drawings. In the description of the following drawings, the identical or similar reference numeral is attached to the identical or similar part. However, it should be noted that the drawings are schematic and the relation between thickness and the plane size and the ratio of the thickness of each component part differs from an actual thing. Therefore, detailed thickness and size should be determined in consideration of the following explanation. Of course, the part from which the relation and ratio of a mutual size differ also in mutually drawings is included.

Moreover, the embodiments shown hereinafter exemplify the apparatus and method for materializing the technical idea of the present invention; and the embodiments of the present invention does not specify the material, shape, structure, placement, etc. of each component part as the following. The embodiments of the present invention may be changed without departing from the spirit or scope of claims.

### Embodiment

### Electrical Capacitor

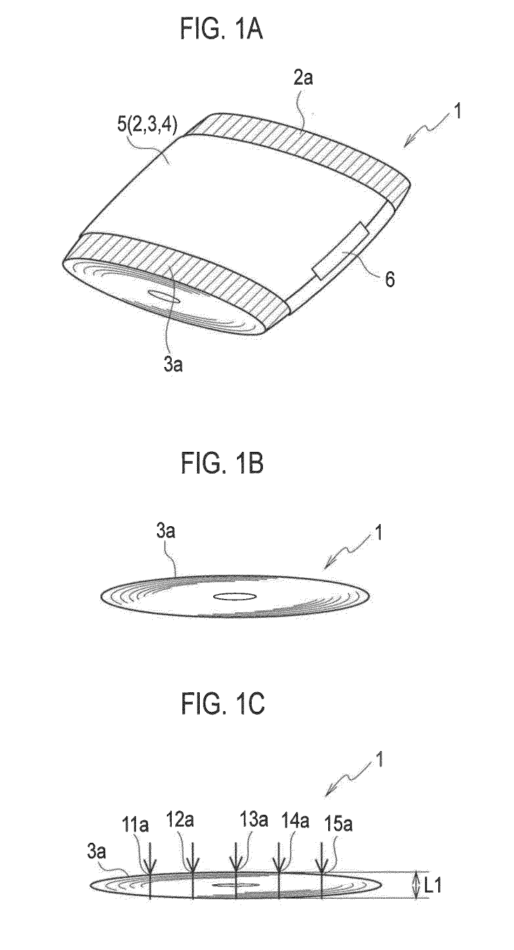

As shown in FIGS. 1A, 1B 1C, 9A-9F, and 12, etc., an electrical capacitor 1 according to the embodiment includes: a band-shaped coating foil 3 for positive electrode having a non-coated part 3a of which an edge of one longitudinal side is not coated with an active material; a band-shaped coating foil 2 for negative electrode having a non-coated part 2a of which an edge of one longitudinal side is not coated with an active material; and a band-shaped separators 4.5 through which an electrolysis solution and ions can pass. Moreover, the coating foil 3 for positive electrode and the coating foil 2 for negative electrode are flatly wound via the separators 4, 5 so that the non-coated part 3a in the side of the coating foil 3 for positive electrode and the non-coated part 2a in the side of the coating foil 2 for negative electrode are exposed in opposite sides to each other, and the electrode group of the non-coated parts 2a, 3a exposed to both sides is bonded.

Moreover, the electrode group of the non-coated parts 2a, 3a may be bonded with electrode tabs 7a, 7b.

Moreover, the length of bonded parts 11a-15a, 11b-15b to which the electrode tabs 7a, 7b are bonded may be respectively equal to or greater than 50% of the length of the electrode group of the non-coated parts 2a, 3a.

Moreover, the electrode group of the non-coated parts 2a, 3a may be respectively bonded with ultrasonic welding or caulking.

Moreover, the electrode group of the non-coated parts 2a, 3a may be subjected to the ultrasonic welding by pressing a welding head 11 against the non-coated parts 2a, 3a once.

Moreover, the electrode group of the non-coated parts 2a, 3a may be subjected to the ultrasonic welding by pressing the welding head 11 against the non-coated parts 2a, 3a several times.

Moreover, the electrode group in which the electrode tabs 7a, 7b are bonded thereto may be covered with a laminate sheet 8.

Moreover, the electrical capacitor 1 may be an electric double-layer capacitor (EDLC) including the above-mentioned configuring elements.

Moreover, the electrical capacitor 1 may be a lithium ion capacitor including the above-mentioned configuring elements.

Moreover, the electrical capacitor 1 may be a lithium ion battery including the above-mentioned configuring elements.

### Comparative Example

### Wound Type

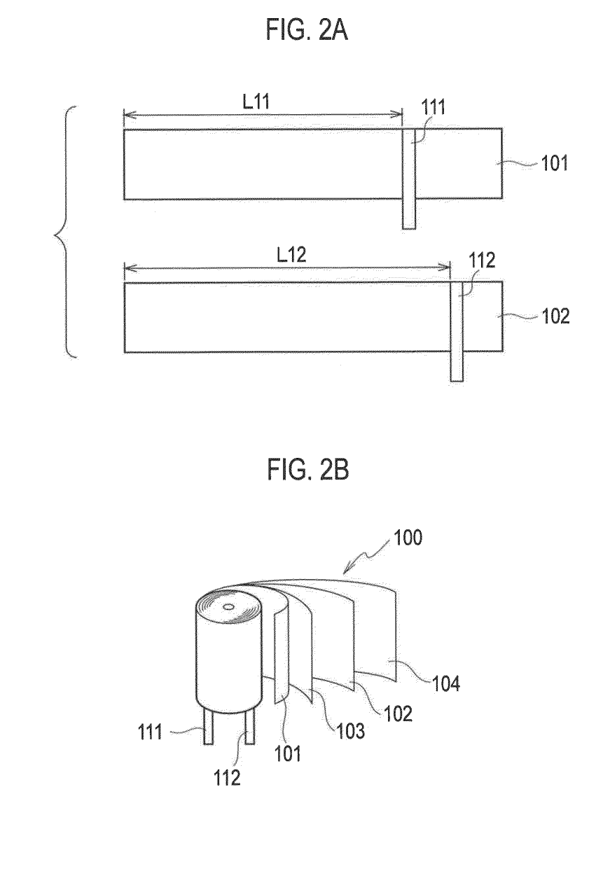

FIGS. 2A and 2B shows a wound type electrical capacitor 100 according to a comparative example. First, as shown in FIG. 2A, an active material is coated on both of a coating foil 101 for positive electrode and a coating foil 102 for negative electrode. Next, an electrode tab 111 is bonded to the coating foil 101 for positive electrode, and an electrode tab 112 is bonded to the coating foil 102 for negative electrode. Subsequently, as shown in FIG. 2B, the coating foil 101 for positive electrode, a separator 103, the coating foil 102 for negative electrode, and a separator 104 are laminated in this order and wound in swirl shape, and then a lead is connected to each electrode tab 111, 112. Since the respective distances L11, L12 from the respective electrode tabs 111, 112 to the respective active-material coated end parts is long in such a wound type electrical capacitor 100, its internal electrical resistance is increased.

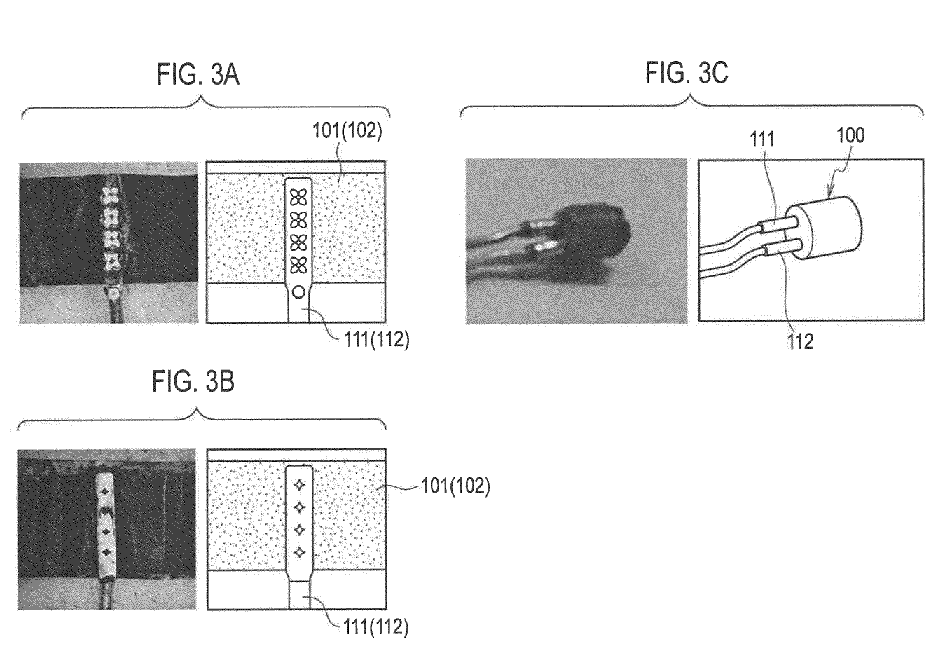

FIGS. 3A to 3C show an example of photographs of the wound type electrical capacitor 100 shown in FIGS. 2A and 2B. FIG. 3A shows a front side surface of the coating foil 101 for positive electrode to which the electrode tab 111 is bonded with the caulking, and FIG. 3B shows a back side surface thereof. The coating foil 102 for negative electrode side is also the same as the coating foil 101. FIG. 3C shows a state where the coating foil 101 for positive electrode and the coating foil 102 for negative electrode are wounding, and then a lead is connected to each electrode tab 111, 112.

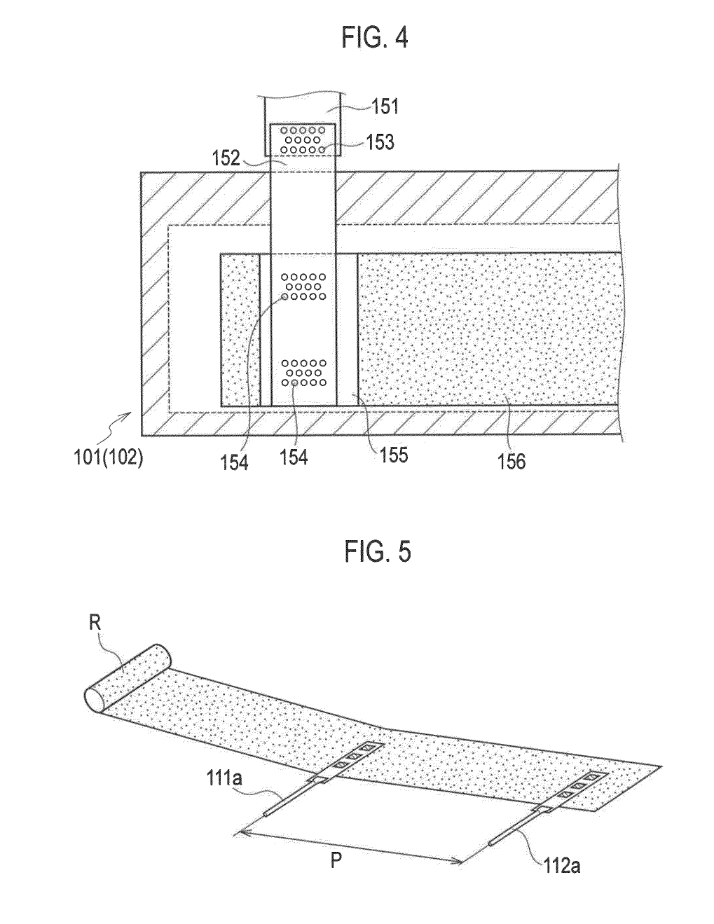

FIG. 4 shows a schematic plane configuration of bonded parts 153, 154 in another wound type electrical capacitor 100 according to a comparative example. As shown in FIG. 4, when bonding the electrode tab 111 with ultrasonic welding, a region subjected to the ultrasonic welding in the coating foil 101 for positive electrode (coating foil 102 for negative electrode) is made un-coating.

More specifically, the coated part 156 is a region where the active material is coated, and, the non-coated part 155 is a region where the active material is not coated (e.g., aluminum foil). One end of an aluminum intermediate tab 152 is bonded to the non-coated part 155 with ultrasonic welding in a bonded part 154. Another end of the aluminum intermediate tab 152 is bonded to a nickel external terminal 151 subjected to plate (Sn) processing with the ultrasonic welding in a bonded part 153.

### Comparative Example

### Electrical Capacitor Module

Next, there will be explained a configuration of an electrical capacitor module according to the comparative example and a fabrication method of such an electrical capacitor module.

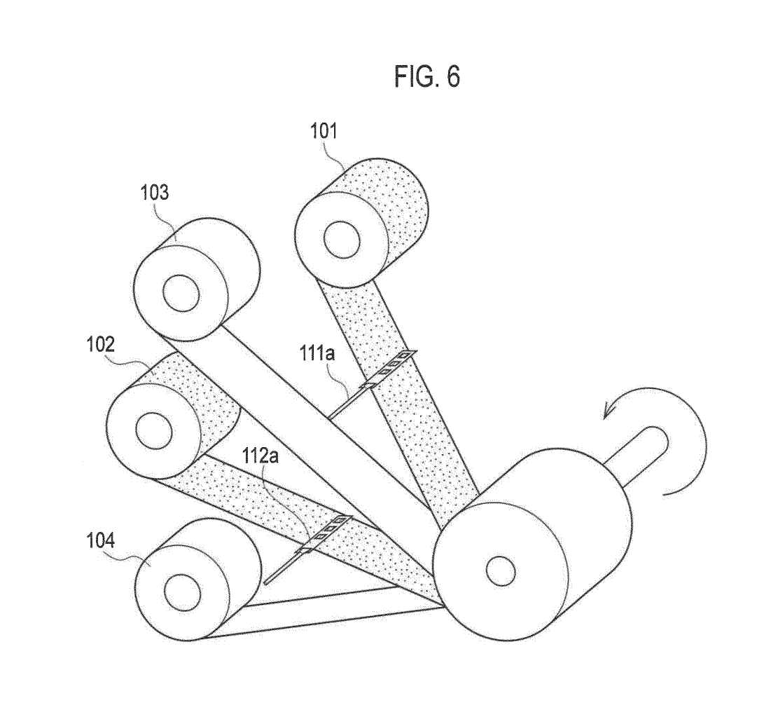

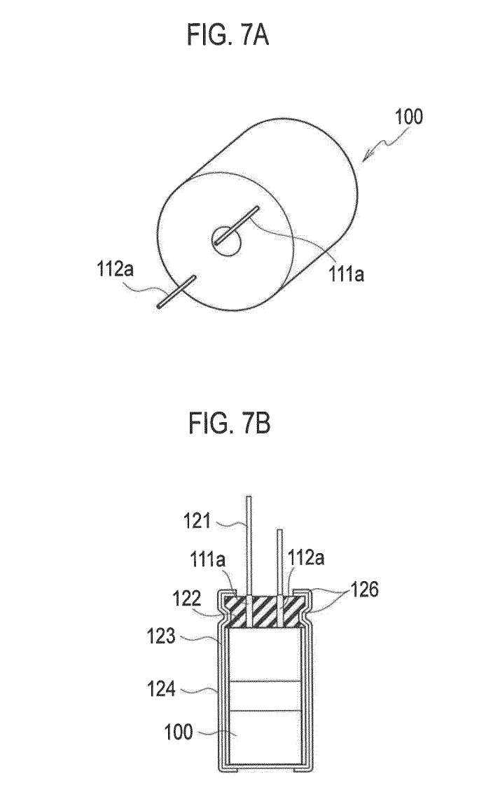

First, as shown in FIG. 5, the active material is coated to a coating foil roll R, and then aluminum electrode tabs 111a, 112a with lead are respectively bonded to the non-coated parts with the caulking. Reference numeral P in FIG. 5 denotes the winding length (pitch) per one electrode tab 111a, 111b with lead. Next, as shown in FIG. 6, the coating foil to which the electrode tabs 111a, 112a with lead are bonded is cylindrically wound. Thus, a cylindrical electrical capacitor 100 from which a pair of the electrode tabs 111a, 112a with lead of projected is obtained, as shown in FIG. 7A. Then, as shown in FIG. 7B, the cylindrical electrical capacitor 100 is housed in a cylindrical case. In FIG. 7B, reference numeral 121 denotes a lead wire, reference numeral 122 denotes rubber packing (sealing material), reference numeral 123 denotes an aluminum case, reference numeral 124 denotes a sleeve, and reference numeral 126 denotes a curling part. The electrical capacitor module is obtained by inserting the electrode tabs 111a, 112a with lead of the electrical capacitor 100 into the rubber packing 122, and then connecting the lead wire 121 thereto.

Next, there will be explained another electrical capacitor module according to the comparative example.

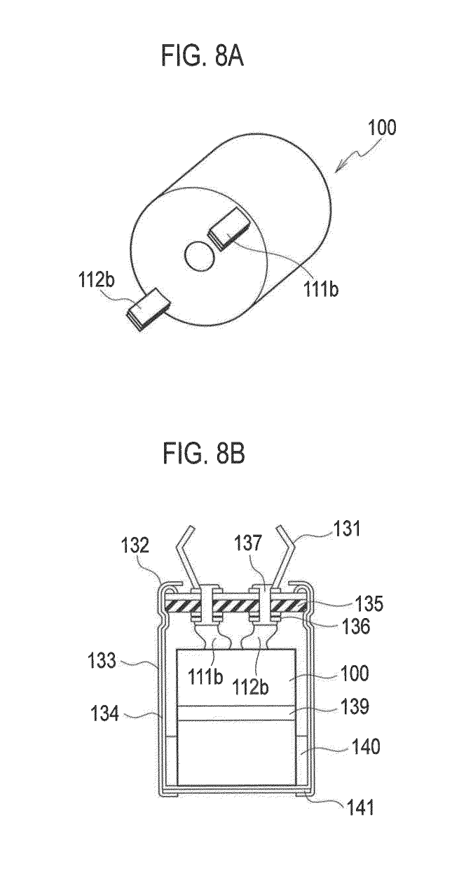

Although the electrode tabs 111a, 112a with lead are used in the example of FIGS. 7A and 7B, plate electrode tabs 111b, 112b may be used instead of the electrode tabs 111a, 112a with lead. In such a case, as shown in FIG. 8A, a cylindrical electrical capacitor 100 from which a pair of the plate electrode tabs 111b, 112b is projected is obtained. Then, as shown in FIG. 8B, the cylindrical electrical capacitor 100 is housed in a cylindrical case. In FIG. 8B, reference numeral 131 denotes a terminal, reference numeral 132 denotes a curling part, reference numeral 133 denotes a sleeve, reference numeral 134 denotes an aluminum case, reference numeral 135 denotes rubber bakelite (sealing material), reference numeral 136 denotes an aluminum washer, reference numeral 137 denotes an aluminum rivet, reference numeral 139 denotes an element fastening tape, reference numeral 140 denotes an element fixing member, and reference numeral 141 denotes a base plate. The electrical capacitor module is obtained by connecting the plate electrode tabs 111b, 112b of the electrical capacitor 100 to the aluminum rivet 137 with the caulking.

### Embodiment

### Pseudo-Laminated Type

FIGS. 1A, 1B and 1C show an electrical capacitor 1 according to the embodiment. FIG. 1A is a schematic bird's-eye view configuration diagram of the electrical capacitor 1 according to the embodiment. FIG. 1B is a schematic side configuration diagram of the electrical capacitor 1 shown in FIG. 1A. FIG. 1C is a schematic side configuration diagram showing a state of bonding the electrode group of the non-coated parts 2a, 3a in the electrical capacitor 1 shown in FIG. 1A.

As shown in FIGS. 1A, 1B and 1C, a coating foil 3 for positive electrode and a coating foil 2 for negative electrode are flatly wounding via separators 4, 5; and then the electrode group of the non-coated parts 2a, 3a exposed to both sides is bonded. Thus, the center portion thereof becomes a structure where the coating foil 3 for positive electrode and the coating foil 2 for negative electrode coated with the active material are wound via the separators 4, 5. On the other hand, both side portions thereof become a structure where the coating foil 3 for positive electrode or the coating foil 2 for negative electrode not coated with the active material are wound. More specifically, since only single electrode is formed on both side portions, the electrodes are not short-circuited even if the electrode group of the non-coated parts 2a, 3a exposed to both sides is bonded. Since such a structure has not only wound type feature but also laminated type feature, it is called “pseudo-laminated type” electrical capacitor, hereinafter.

As shown in FIG. 1C, according to the pseudo-laminated type structure, the internal electrical resistance can be reduced to be lower than the wound type structure since the distance L1 from the bonded parts 11a-15a to the active material end becomes shorter than that of the wound type structure (comparative example). For example, in the case of the internal electrical resistance of the wound type electrical capacitor 100 is 50 mΩ, the internal electrical resistance of the pseudo-laminated type electrical capacitor 1 has the capacitor same as that of the wound type electrical capacitor 100 is approximately 20 mΩ. More specifically, if the pseudo-laminated type electrical capacitor is used, the internal electrical resistance thereof can be reduced up to approximately 40% of the wound type electrical capacitor.

Moreover, in actual use, a dead space can be formed since the wound type electrical capacitor 100 is cylindrical. Since the pseudo-laminated type electrical capacitor 1 is a thin type, the electrical capacitors 1 can be laminated, thereby achieving space saving.

Furthermore, the capacity can be readily increased by using the pseudo-laminated type electrical capacitor compared with the laminated type electrical capacitor. More specifically, the pseudo-laminated type electrical capacitor is suitable for achieving high capacity since the electrodes can be efficiently opposed to each other, in the same manner as the wound type electrical capacitor.

### (Fabrication Method)

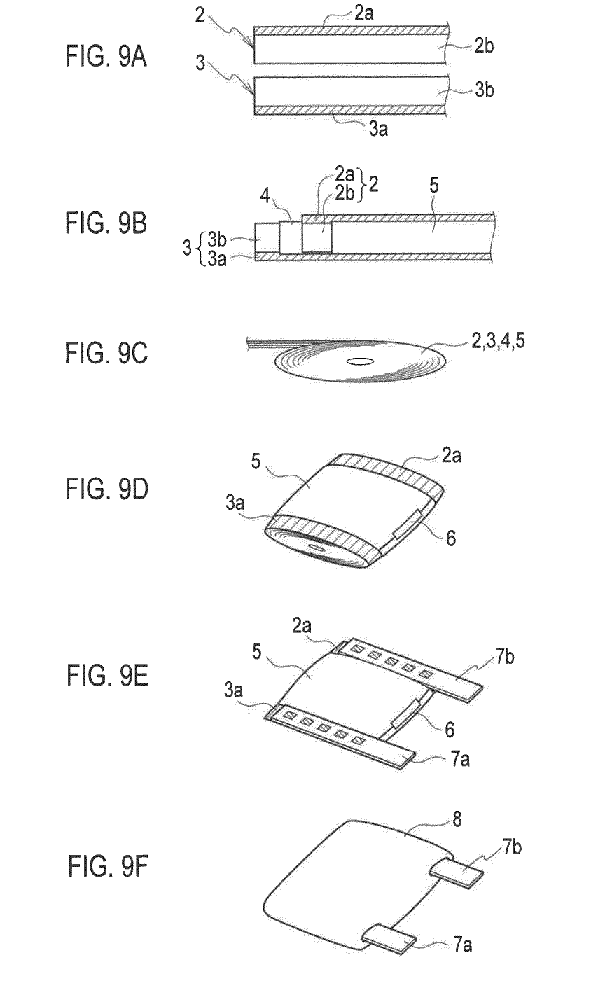

As shown in FIGS. 9A-9F, the fabrication method of the electrical capacitor 1 according to the embodiment including: coating the active material other than the edge of one longitudinal side of the band-shaped coating foil 3 for positive electrode; coating the active material other than the edge of one longitudinal side of the band-shaped coating foil 2 for negative electrode; laminating the coating foil 3 for positive electrode and the coating foil 2 for negative electrode via the separators 4, 5 so that the non-coated part 3a in the side of coating foil 3 for positive electrode and the non-coated part 2a in the side of coating foil 2 for negative electrode are exposed in opposite sides to each other; flatly winding the laminated electrode group; and bonding the electrode group of the non-coated parts 2a, 3a wound to be exposed to both sides. Hereinafter, these processing steps will be explained in more detail with reference to FIGS. 9A-9F.

First, as shown in FIG. 9A, the active material is coated on the coated part 3b of the coating foil 3 for positive electrode. The coated part 3b is a portion other than the non-coated part 3a (edge of one longitudinal side of the band-shaped coating foil 3 for positive electrode). Similarly, the active material is coated also on the coated part 2b of the coating foil 2 for negative electrode. The coated part 2b is a portion other than the non-coated part 2a (edge of one longitudinal side of the band-shaped coating foil 2 for negative electrode). Materials of the active material, the coating foil 3 for positive electrode, and the coating foil 2 for negative electrode will be described below.

Next, as shown in FIG. 9B, the coating foil 3 for positive electrode, the separator 4, the coating foil 2 for negative electrode, and the separator 5 are laminated in this order. At this time, the laminating position of the coating foil 3 for positive electrode and the laminating position of the coating foil 2 for negative electrode are displaced from their positions in the short-side direction so that the non-coated part 3a and the non-coated part 2a can be exposed in opposite sides to each other. Moreover, the separators 4, 5 having larger area (wider area) than that of the coated parts 3a, 3b are used so that the separators 4, 5 can cover the whole coated parts 3a, 3b.

Next, as shown in FIG. 9C, the laminated electrode group (the coating foil 3 for positive electrode, the separator 4, the coating foil 2 for negative electrode, and the separator 5) is flatly wound. Although the flatness is not particularly limited, the distance L1 from the bonded parts 11a-15a to the active material end is shortened as the flatness is increased, thereby reducing the internal electrical resistance.

Thus, as shown in FIG. 9D, the flatly-wound electrode group can be formed. The coating foil 3 for positive electrode and the coating foil 2 for negative electrode are flatly wound via the separators 4, 5; and thereby the electrode group of the non-coated parts 2a, 3a is exposed to both sides. The edge part of the separator 5 is fixed with a seal 6 etc.

Next, as shown in FIG. 9E, the electrode group of the respective non-coated parts 2a, 3a already exposed to both sides is bonded with the respective electrode tabs 7a, 7b. Although the bonding method is not particularly limited, the electrode group can be bonded with the electrode tab by ultrasonic welding or a caulking, for example.

Finally, as shown in FIG. 9F, the electrode group to which the electrode tabs 7a, 7b are bonded is covered with the laminate sheet 8. The laminate sheet 8 is subjected to pressing treatment so as to become an outside shape for wrapping the electrode group to which the electrode tabs 7a, 7b are bonded.

### (Winding Device)

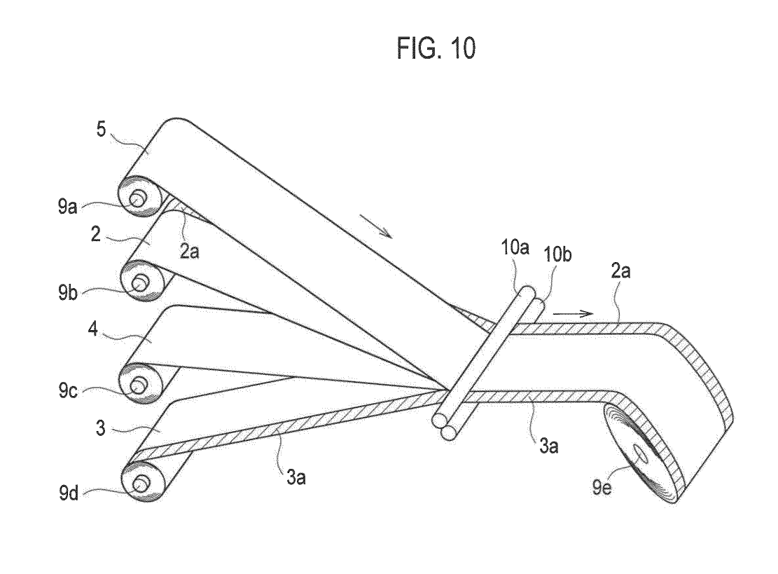

FIG. 10 shows a schematic bird's-eye view configuration of a winding device used for the fabrication of the electrical capacitor 1 according to the embodiment. As shown in FIG. 10, the winding device includes: a roll-shaped separator feeding unit 9a configured to feed the separator 5; a roll-shaped coating foil for negative electrode feeding unit 9b configured to feed the coating foil 2 for negative electrode; a roll-shaped separator feeding unit 9c configured to feed the separator 4; and a roll-shaped coating foil for positive electrode feeding unit 9d configured to feed the coating foil 3 for positive electrode. The separator 5 fed from the separator feeding unit 9a, the coating foil 2 for negative electrode fed from the coating foil for negative electrode feeding unit 9b, the separator 4 fed from the separator feeding unit 9c and the coating foil 3 for positive electrode fed from a coating foil for positive electrode feeding unit 9d pass through roller pairs 10a, 10b, and are rolled round in flat shape by the winding reel 9e. In the present embodiment, although the case where the electrode group is rolled round in flat shape is exemplified, the electrode group may be flatly deformed, after rolling round the electrode group circularly.

### (Bonding Method)

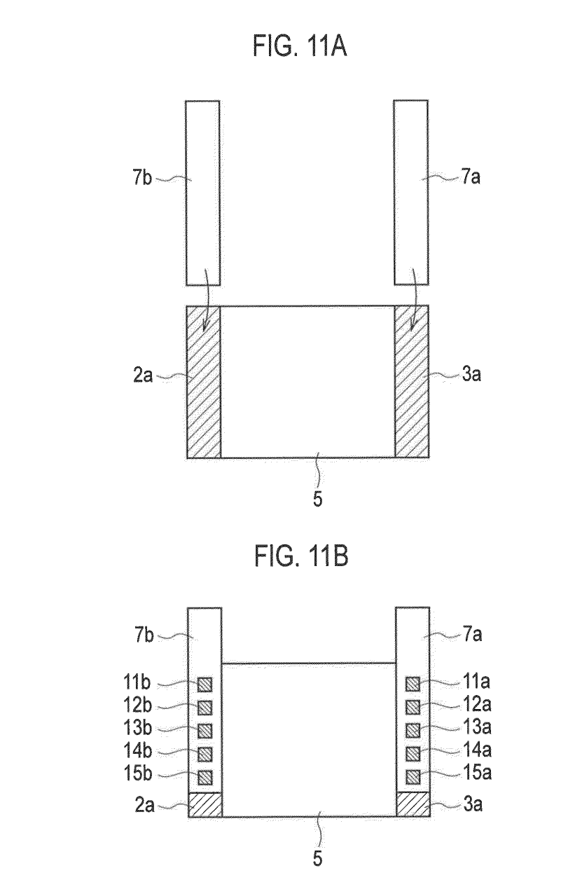

FIGS. 11A and 11B show a schematic plane configuration of an aspect that the electrode tabs 7a, 7b are bonded in the electrical capacitor 1 according to the embodiment. First, as shown in FIG. 11A, the electrode tab 7b is disposed on the non-coated part 2a, and the electrode tab 7a is also disposed on the non-coated part 3a. Since the non-coated parts 2a, 3a are flat shape, the electrode tabs 7a, 7b can be easily disposed thereon. Subsequently, as shown in FIG. 11B, the electrode group of the non-coated part 2a is bonded with the electrode tab 7b at bonded parts 11b, 12b, 13b, 14b and 15b. The same manner is also applied in bonded parts 11a, 12a, 13a, 14a and 15a in the opposite side. In the present embodiment, although the case where the electrode tabs 7a, 7b are bonded to the non-coated parts 2a, 3a in parallel is exemplified, the bonding positions of the electrode tabs 7a, 7b are not limited to the above-mentioned positions (as describes below).

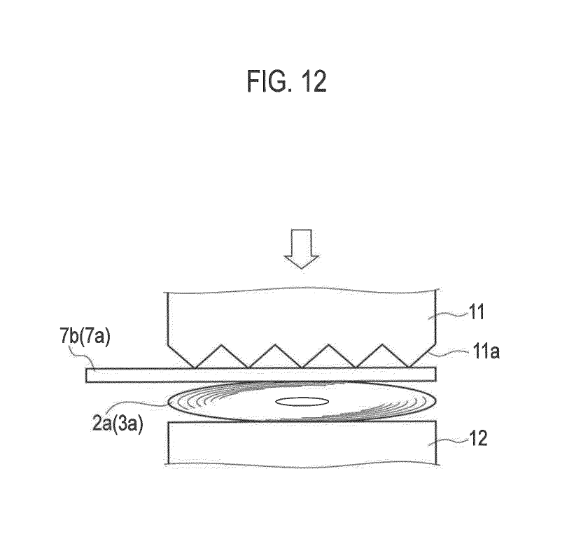

FIG. 12 shows a schematic side surface configuration of an aspect that the electrode group of the non-coated parts 2a, 3a of shown in FIG. 11 is bonded by ultrasonic welding. As shown in FIG. 12, the electrode group of the electrode tab 7b (7a) and the non-coated part 2a (3a) are sandwiched between a welding head 11 and an anvil 12. Moreover, ultrasonic vibrations are given from the ultrasonic bonding surface 11a of the welding head 11, pressing a welding head 11 to apply pressure thereon, and welding is performed utilizing frictional heat generated by the vibration. A bonding surface having a plurality of quadrangles, the so-called diamond cut pattern, can be used as the ultrasonic bonding surface 11a.

In the present embodiment, although the case where the whole electrode group of the non-coated parts 2a, 3a is subjected to the ultrasonic welding by pressing the welding head 11 thereon once is exemplified, the method of the ultrasonic welding is not limited to the above-mentioned method since there are different methods. For example, ultrasonic welding of the non-coated parts 2a, 3a larger than the non-coated parts 2a, 3a shown in FIG. 12 can also be achieving using the welding head 11 shown in FIG. 12. In this case, the whole electrode group of the non-coated parts 2a, 3a will be subjected to the ultrasonic welding by pressing the welding head 11 thereon several times.

### (The Length of Bonded Part)

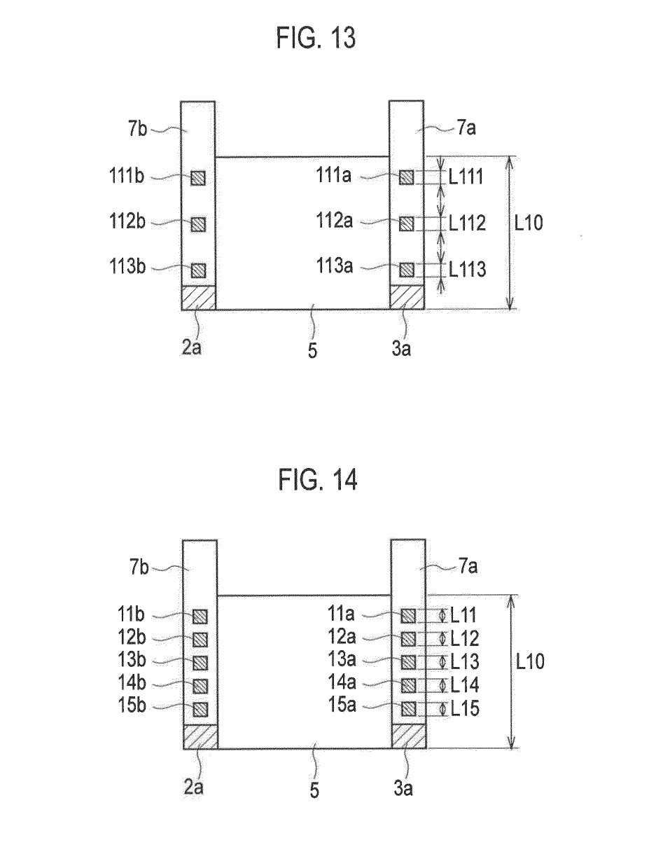

FIG. 13 shows a schematic plane configuration of bonded parts 111a, 112a and 113a in the electrical capacitor 100 according to the comparative example. As shown in FIG. 13, the length of bonded parts 111a, 112a and 113a (L111+L112+L113) to which the electrode tab 7a is bonded is about 30% of the length L10 of the electrode group of the non-coated part 3a. The same manner is also applied in the bonded parts 111b, 112b and 113b in the opposite side.

FIG. 14 shows a schematic plane configuration of the bonded parts 11a, 12a, 13a, 14a and 15a in the electrical capacitor 1 according to the embodiment. As shown in FIG. 14, the length of the bonded parts 11a, 12a, 13a, 14a and 15a (L11+L12+L13+L14+L15) to which the electrode tab 7a is bonded is equal to or greater than 50% of the length L10 of the electrode group of the non-coated part 3a. The same manner is also applied in the bonded parts 11b, 12b, 13b, 14b and 15b in the opposite side.

According to such a configuration, the thermal dispersion characteristics thereof can be improved rather than that of the comparative example. More specifically, increase in temperature may become a problem since the thermal dispersion characteristics of the wound type inside the electrode group are inferior. Consequently, as a result of a simulation regarding the thermal dispersion characteristics, it is proved that since a portion which is highest level of heat radiation is the portion of the electrode tabs 7a, 7b, it is effective to increase the length of the bonded parts bonded to the electrode tabs 7a, 7b. More specifically, it is preferable that the length of the bonded parts 11a, 12a, 13a, 14a and 15a (L11+L12+L13+L14+L15) is set to equal to or greater than 50% of the length L10 of the electrode group of the non-coated part 3a. Accordingly, the problem of increase in temperature is avoidable since plenty of heat is radiated through the bonded parts 11a, 12a, 13a, 14a and 15a.

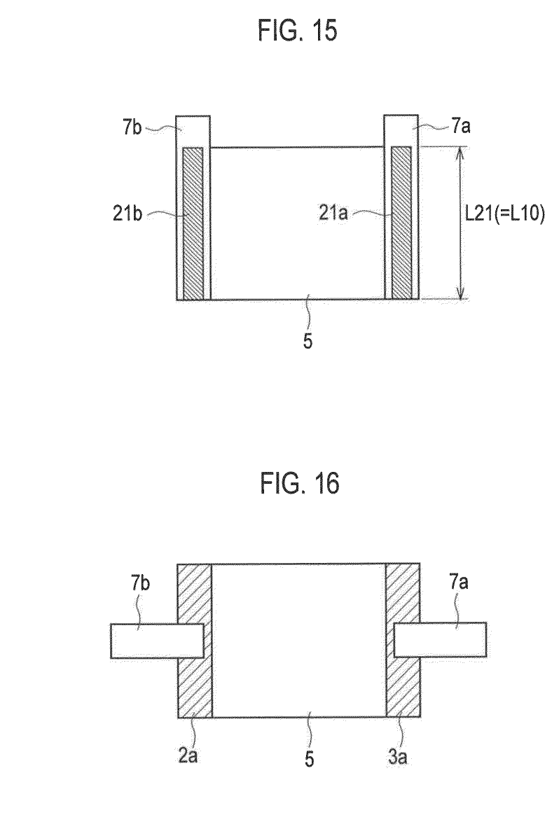

FIG. 15 shows a schematic plane configuration of an alternative bonded part 21a in the electrical capacitor 1 according to the embodiment. As shown in FIG. 15, the length (L21) of the bonded part 21a to which the electrode tab 7a is bonded is substantially equal to that of the electrode group of the non-coated part 3a. The same manner is also applied in the bonded part 21b in the opposite side. According to such a configuration, the thermal dispersion characteristics can be further improved since the bonded part becomes longer than that of the example shown in FIG. 14.

### (Modified Example of Bonding Position of Electrode Tab)

FIG. 16 shows a schematic plane configuration of a modified example 1 of the bonding position of the electrode tabs 7a, 7b in the electrical capacitor 1 according to the embodiment. As shown in FIG. 16, the electrode tab 7b may be extracted from the substantially central part in the non-coated part 2a in one direction (left direction) of the winding axial direction. Moreover, the electrode tab 7a may be extracted from the substantially central part in the non-coated part 3a in other direction (right direction) of the winding axial direction. Accordingly, the electrode tabs 7a, 7b can be respectively extracted from the two facing sides of the electrical capacitor 1.

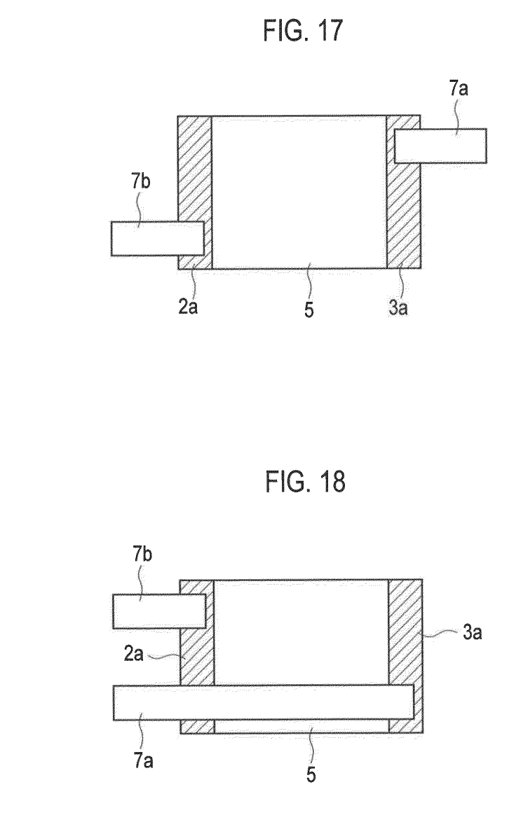

FIG. 17 shows a schematic plane configuration of a modified example 2 of the bonding position of the electrode tabs 7a, 7b in the electrical capacitor 1 according to the embodiment. As shown in FIG. 17, the electrode tab 7b may be extracted from one end (lower end) of the non-coated part 2a in one direction (left direction) of the winding axial direction. Moreover, the electrode tab 7a may be extracted from other end (upper end) in the non-coated part 3a in other direction (right direction) of the winding axial direction. Accordingly, the electrode tabs 7a, 7b can be extracted from near the two peaks which are not adjacent to each other in the electrical capacitor 1.

FIG. 18 shows a schematic plane configuration of a modified example 3 of the bonding position of the electrode tabs 7a, 7b in the electrical capacitor 1 according to the embodiment. As shown in FIG. 18, the electrode tab 7b may be extracted from one end (upper end) of the non-coated part 2a in one direction (left direction) of the winding axial direction. Moreover, the electrode tab 7a may be extracted from other end (lower end) in the non-coated part 3a in other direction (left direction) of the winding axial direction. Accordingly, the electrode tabs 7a, 7b can be extracted from only one side of the electrical capacitor 1.

As mentioned above, according to the electrical capacitor 1 related to an embodiment, the electrode group is flatly wounding, and then the electrode group of the non-coated parts 2a, 3a exposed to both sides is bonded. Therefore, the internal electrical resistance of the electrical capacitor 1 can be further reduced compared with the wound type, and the capacity thereof can be readily increased compared with the laminated type.

### Embodiment

### Electrical Capacitor Module

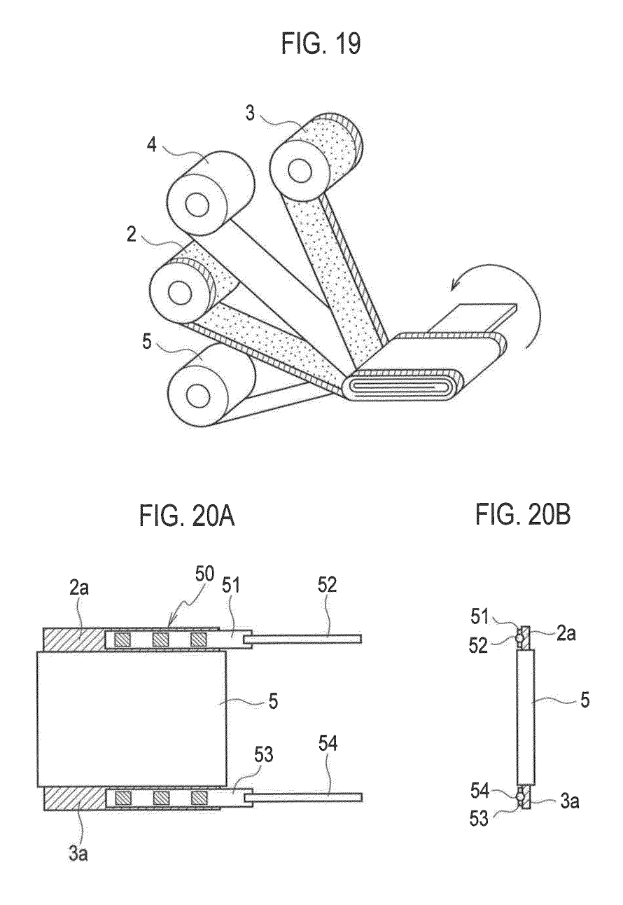

FIGS. 19-23 show an electrical capacitor module according to the embodiment. As shown in FIG. 19-FIG. 23, pin-shaped lead terminals 52, 54 are respectively connected to the electrode tabs 51, 53, and the lead terminals 52, 54 are projected to the outside of the laminate sheet 55. Moreover, the boundary portions between the edge part of the laminate sheet 55 and the respective lead terminals 52, 54 are fixed with resin 56, 57. Furthermore, the electrical capacitor 1 is housed in a box-type case 65, and the lead terminals 52, 54 are connected to a PCB substrate 61. A plurality of the electrical capacitors 1_1, 1_2, 1_3 and 1_4 may be connected to each other in series, in parallel, or in series parallel. Moreover, voltage balance control circuits 62_1, 62_2, 62_3 and 62_4 which control a voltage balance may be provided on the PCB substrate 61.

Hereinafter, the configuration the fabrication method of such an electrical capacitor module will be explained.

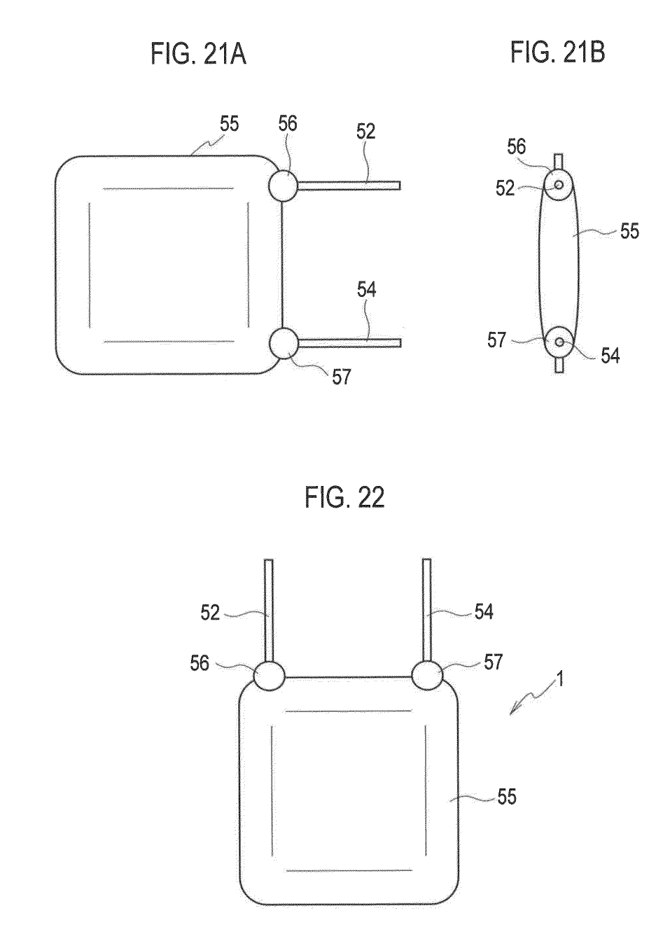

First, as shown in FIG. 19, the coating foil 3 for positive electrode, the separator 4, the coating foil 2 for negative electrode, and the separator 5 are flatly wound. Next, as shown in FIGS. 20A and 20B, the electrode group of the non-coated parts 2a, 3a exposed to both sides is bonded with electrode tabs 51, 53 at the bonded part 50. In the present embodiment, the respective pin-shaped lead terminals 52, 54 are connected to the respective electrode tabs 51, 53 which are plate-shaped aluminum tabs. The lead terminals 52, 54 are terminals formed by applying nickel plating or tin plating to Cu or Fe. One end of the lead terminals 52, 54 is formed as a bifurcated terminal, and has structure for sandwiching the electrode tabs 51, 53. Needless to say, the connection method of the electrode tabs 51, 53; and the lead terminals 52, 54 is not limited to the above-mentioned method, and various connection methods can be adopted thereto. Next, as shown in FIGS. 21A and 21B, the electrode group to which the electrode tabs 51, 53 are bonded is stored in a lamination cup already subjected to a drawing compound. Then, aging is executed after pouring an electrolysis solution, a final seal to seal the electrolysis solution is executed. At the time of the above-mentioned final seal, the lead terminals 52, 54 is provided outside of the edge part of the laminate sheet 55, and then the boundary portion between the edge part of the laminate sheet 55 and the respective lead terminals 52, 54 are fixed and reinforced with the resin 56, 57. Accordingly, as shown in FIG. 22, there can be obtained the electrical capacitor 1 in which the pin-shaped lead terminals 52, 54 are projected to the outside of the laminate sheet 55.

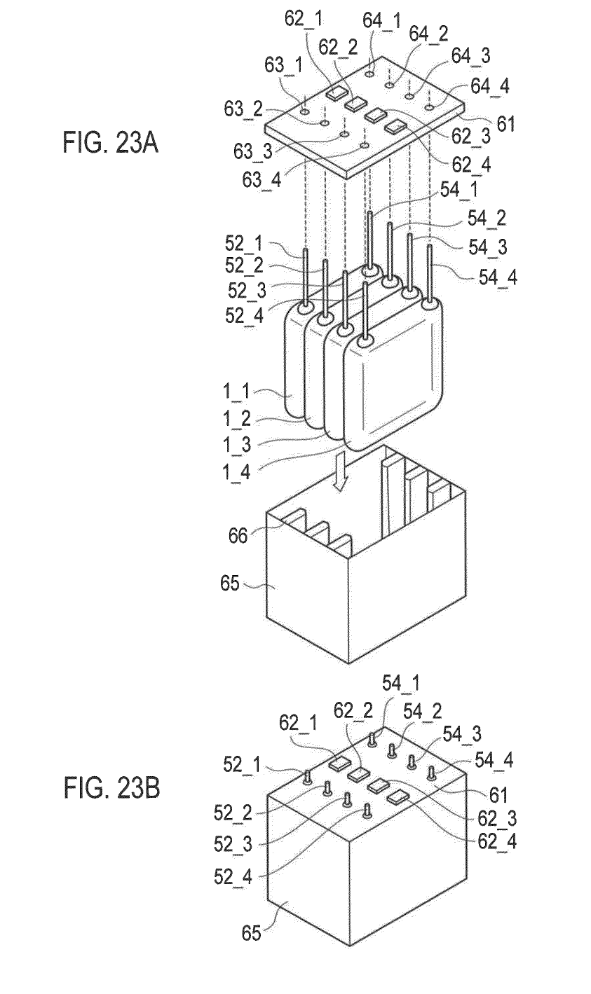

Next, as shown in FIG. 23A, such four electrical capacitors 1_1, 1_2, 1_3 and 1_4 are housed in the box-type case 65. A guide member 66 for housing four electrical capacitors 1_1, 1_2, 1_3 and 1_4 in the fixed position is formed in the box-type case 65. Next, the upper part of the box-type case 65 is covered with the PCB substrate 61, and then the lead terminals 52_1 to 52_4 and 54_1 to 54_4 are thrust to be soldered into through holes 63_1 to 63_4 and 64_1 to 64_4 formed in the PCB substrate 61. Accordingly, as shown in FIG. 23B, there can be obtained the box type electrical capacitor module in which the lead terminals 52_1 to 52_4 and 54_1 to 54_4 are projected from the PCB substrate 61. The four electrical capacitors 1_1, 1_2, 1_3 and 1_4 can be connected to each other in series, in parallel, or in series parallel by mutually wiring the lead terminals 52_1 to 52_4 and 54_1 to 54_4. Needless to say, the number of the electrical capacitors 1 is not limited to four pieces, and 200 pieces (40 rows×5 columns) of the electrical capacitors 1 may be connected in series parallel, for example.

The voltage balance control circuits 62_1, 62_2, 62_3 and 62_4 which control the voltage balance are mounted on the PCB substrate 61. For example, in the case of connecting four electrical capacitors 1_1, 1_2, 1_3 and 1_4 in series, the voltage balance control circuits 62_1, 62_2, 62_3 and 62_4 are connected in parallel to each electrical capacitor. Concrete examples of the voltage balance control circuits 62_1, 62_2, 62_3 and 62_4 will be described below.

### Embodiment

### Modified Example of Electrical Capacitor Module

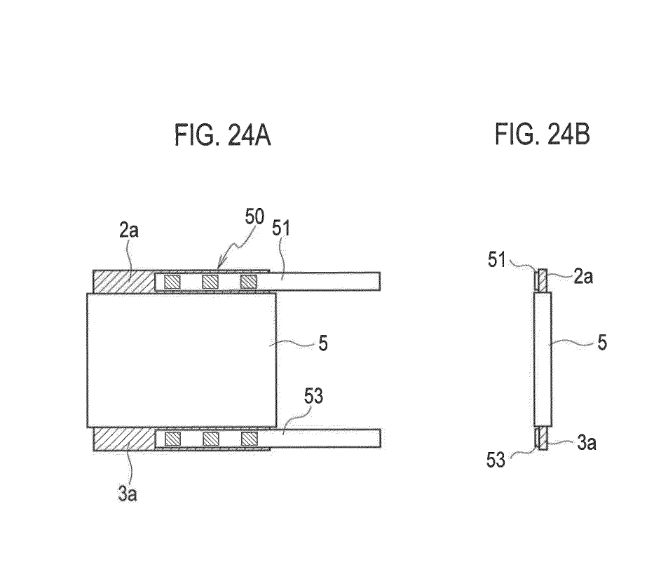

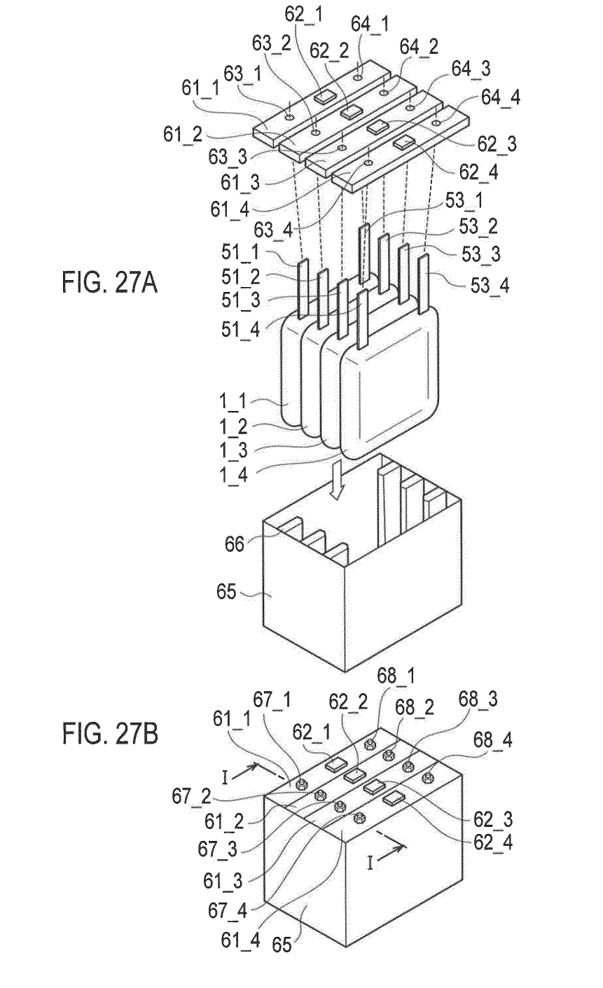

Next, FIGS. 24-28 show a modified example of the electrical capacitor module according to the embodiment. As shown in FIGS. 27A and 27B, the respective PCB substrates 61_1, 61_2, 61_3 and 61_4 on which the respective voltage balance control circuits 62_1, 62_2, 62_3 and 62_4 are mounted may be provided for the respective electrical capacitors 1_1, 1_2, 1_3 and 1_4.

Moreover, the electrical capacitors 1_1, 1_2, 1_3 and 1_4 may be housed in the box-type case 65, and the respective electrode tabs 51_1 to 51_4 and 53_1 to 53_4 may be connected to the respective PCB substrates 61_1, 61_2, 61_3 and 61_4. More specifically, the electrode tabs 51, 53 which are plate-shaped aluminum tabs can also be connected directly to the PCB substrate 61, without connecting the pin-shaped lead terminals 52, 54.

Hereinafter, the configuration the fabrication method of such an electrical capacitor module will be explained.

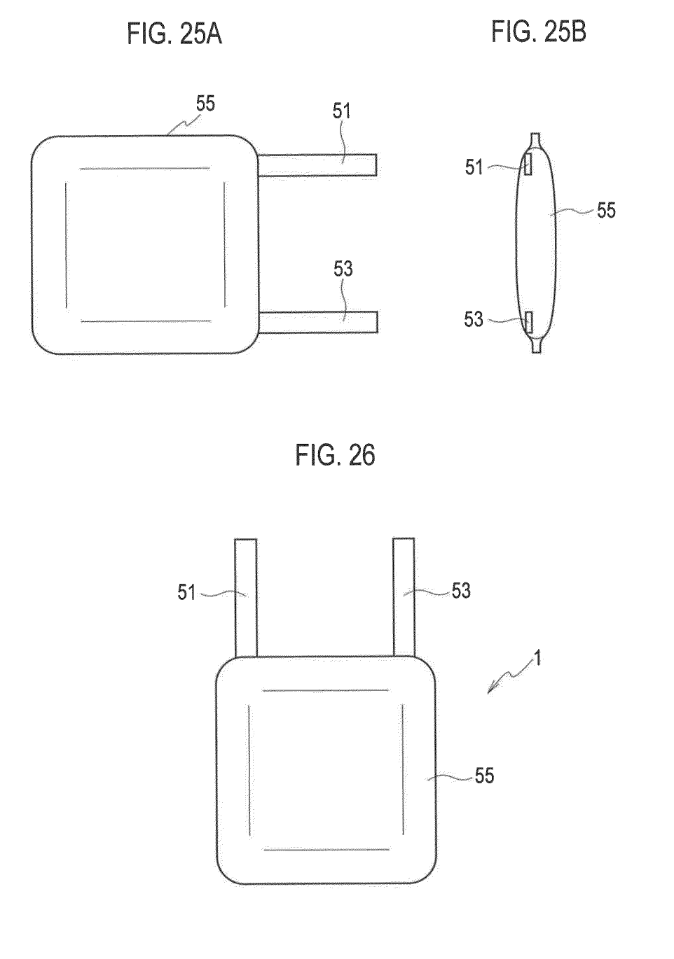

First, the coating foil 3 for positive electrode, the separator 4, the coating foil 2 for negative electrode, and the separator 5 are flatly wound (as shown in FIG. 19). Next, as shown in FIGS. 24A and 24B, the electrode group of the non-coated parts 2a, 3a exposed to both sides is bonded with electrode tabs 51, 53 at the bonded part 50. Next, as shown in FIGS. 25A and 25B, the electrode group to which the electrode tabs 51, 53 are bonded is stored in a lamination cup already subjected to a drawing compound. Then, aging is executed after pouring an electrolysis solution, a final seal to seal the electrolysis solution is executed. Accordingly, as shown in FIG. 26, there can be obtained the electrical capacitor 1 in which the electrode tabs 51, 53 which are plate-shaped aluminum tabs are projected to the outside of the laminate sheet 55.

Next, as shown in FIG. 27A, such four electrical capacitors 1_1, 1_2, 1_3 and 1_4 are housed in the box-type case 65. Next, the upper part of the box-type case 65 are covered with the four PCB substrates 61_1, 61_2, 61_3 and 61_4 on which the voltage balance control circuits 62_1, 62_2, 62_3 and 62_4 are mounted. At this time, the respective four PCB substrates 61_1, 61_2, 61_3 and 61_4 are made to oppose the respective four electrical capacitors 1_1, 1_2, 1_3 and 1_4. Finally, the respective electrode tabs 51_1 to 51_4 and 53_1 to 53_4 are screwed to the respective through holes 63_1 to 63_4 and 64_1 to 64_4 formed in the respective PCB substrates 61_1, 61_2, 61_3 and 61_4, thereby obtaining the box type electrical capacitor module as shown in FIG. 27B.

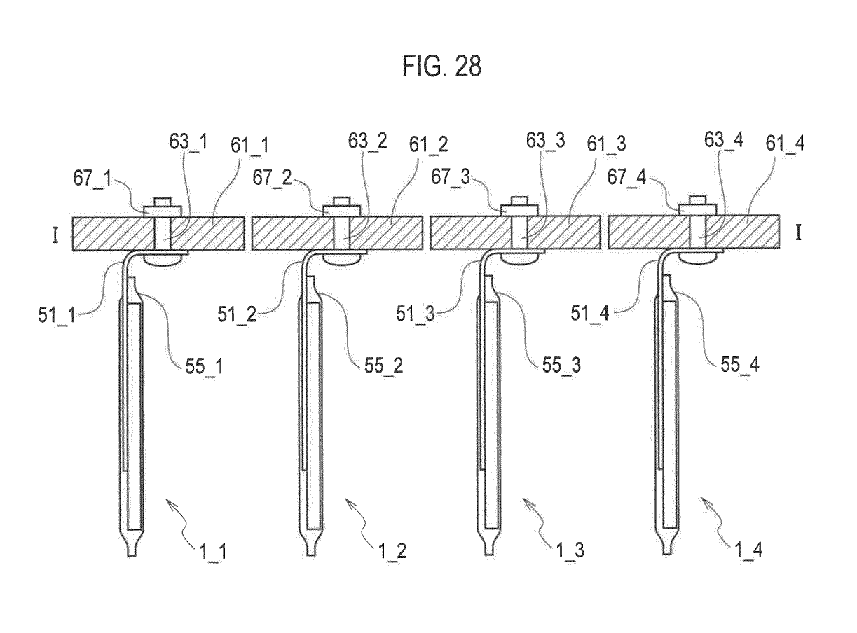

More specifically, as shown in FIG. 28, the electrode tab 51_4 is screwed directly to the through hole 63_4 formed in the PCB substrate 61_4 with the screw 67_4. As a result, even if the respective pin-shaped lead terminals 52, 54 are not connect to the respective electrode tabs 51, 53, the respective electrical capacitors 1_1, 1_2, 1_3 and 1_4 can be electrically connected to the respective PCB substrates 61_1, 61_2, 61_3 and 61_4.

As mentioned above, according to the electrical capacitor module according to the embodiment, the laminated-type thin electrical capacitor 1 is housed in the box-type case, thereby achieving the miniaturization thereof. Moreover, since the flatly-wound electrical capacitor 1 is used, the internal electrical resistance (Equivalent Series Resistance: ESR) can be reduced, thereby readily achieving high power thereof. Furthermore, when a plurality of the electrical capacitor modules are mounted on a printed circuit board, a dead space can be generated since the electrical capacitor module according to the comparative example is cylindrical. On the other hand, the box type electrical capacitor module according to the embodiment can reduce the generating of such a dead space.

### (Concrete Example of Voltage Balance Control Circuit)

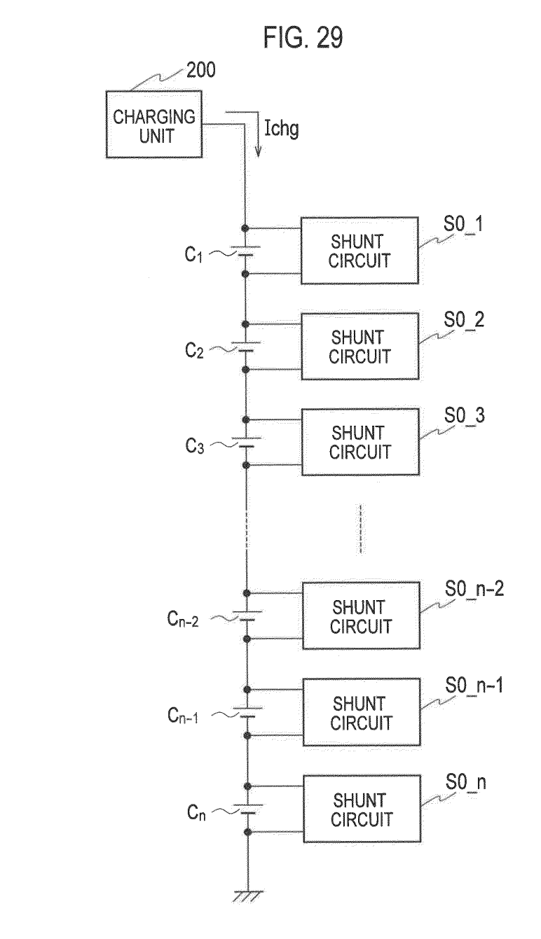

Next, a shunt circuit will now be explained as a concrete example of the voltage balance control circuit provided in the electrical capacitor module according to the embodiment. More specifically, as shown in FIG. 29, the electrical capacitor module according to the embodiment includes; a plurality of cells C₁, C₂, C₃, . . . , Cₙ₋₂, Cₙ₋₁ and Cₙ connected in series to a charging unit 200 which generates a charging current I_{chg}; and a plurality of shunt circuits S0_1, S0_2, S0_3, . . . , S0_{—}n−2, S0_{—}n−1 and S0_{—}n respectively connected in parallel to the plurality of the cells C₁, C₂, C₃, . . . , Cₙ₋₂ Cₙ₋₁ and Cₙ.

Each cell C₁, C₂, C₃, . . . , Cₙ₋₂, Cₙ₋₁ and Cₙ corresponds to the electrical capacitor 1. If the cells C₁, C₂, C₃, . . . , Cₙ₋₂, Cₙ₋₁ and Cₙ are lithium ion battery cells, approximately five to sixteen pieces of the cells are connected in series by vertically laying, for example. Moreover, the respective shunt circuits S0_1, S0_2, S0_3, . . . , S0_{—}n−2, S0_{—}n−1 and SO_{—}n which are in the same number as the cells are connected in parallel to the respective cells C₁, C₂, C₃, . . . , Cₙ₋₂ Cₙ₋₁ and Cₙ.

The charging energy is uniformly stored in each cell C₁, C₂, C₃, . . . , Cₙ₋₂, Cₙ₋₁ and Cₙ in proportion to the electric current time product of the battery current I_{bat}. Therefore, although the cell having the smallest capacitor reaches full-charge voltage firstly, the electric charging is continued until all the cells C₁, C₂, C₃, . . . , Cₙ₋₂, Cₙ₋₁ and Cₙ reach the full-charge voltage.

Consequently, each cell C₁, C₂, C₃, . . . , Cₙ₋₂, Cₙ₋₁ and Cₙ are provided with bypass lines, the charging current I_{chg} to the cell(s) having higher battery voltage V_{bat} are bypassed, and only the cell(s) having lower battery voltage V_{bat} is charged, and thereby uniforming the cell voltage. For example, if the cell C₁ firstly reaches the full-charge voltage, the shunt circuit S0_1 shunts shunt current Iₛₕᵤₙₜ from the charging current I_{chg} to avoid the overcharge of the cell C₁. The same manner is also applied in other shunt circuits S0_2, . . . , S0_{—}n.

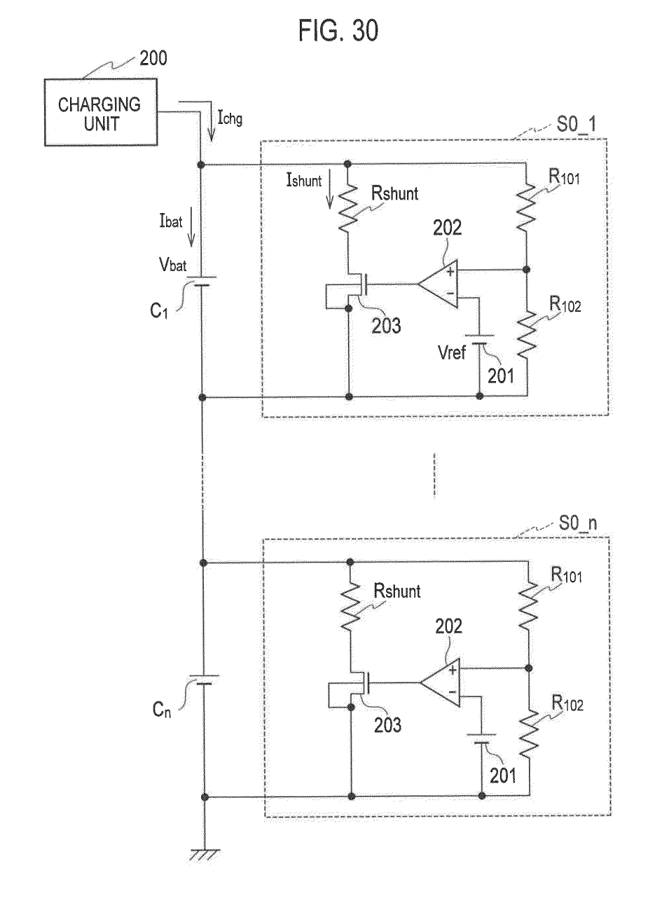

FIG. 30 shows a detailed schematic circuit block configuration of the shunt circuit S0_1, . . . , S0_{—}n shown in FIG. 29. As shown in FIG. 30, a non-inversed input terminal of an operational amplifier 202 is connected to both terminals of the cell C₁ through resistors R₁₀₁, R₁₀₂, and an inversed input terminal thereof is connected to a negative terminal of the cell C₁ through a reference voltage generator 201. The drain of a transistor 203 is connected to the positive terminal of the cell C₁ through the shunt resistor Rₛₕᵤₙₜ, the source is connected to the negative terminal of the cell C₁, and the gate is connected to the output terminal of the operational amplifier 202.

### (EDLC Internal Electrode)

FIG. 31 illustrates a fundamental structure of EDLC internal electrode, in the electrical capacitor 1 according to the embodiment. The EDLC internal electrode is composed so that the separator 40 through which only the electrolysis solution and ions can pass is inserted between the active material electrodes 21, 31 having at least one layer, and the extraction electrodes 20a, 30a are exposed from the active material electrodes 21, 31, and the extraction electrodes 20a, 30a are connected to a power supply voltage. The extraction electrodes 20a, 30a are formed of aluminum foil, for example, and the active material electrodes 21, 31 are formed of activated carbon, for example. The separator 40 of which the size is larger (the area is wider) than that of the active material electrodes 21, 31 is used for covering whole of the active material electrodes 21, 31. Although the separator 40 is not theoretically dependent on a kind of energy device, high thermal resistance is required when in particular corresponding to a reflow is needed. As the separator 40, polypropylene etc. can be used when high thermal resistance is not required, or cellulosic based materials can be used when high thermal resistance is required. The electrolysis solution 44 is impregnated in the EDLC internal electrode, and the electrolysis solution and ions are moved through the separator 40 at the time of charge and discharge.

### (Lithium ion Capacitor Internal Electrode)

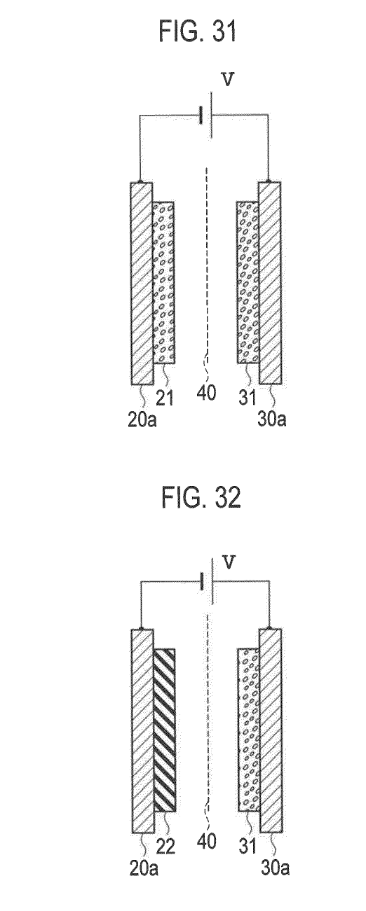

FIG. 32 illustrates a fundamental structure of a lithium ion capacitor internal electrode, in the electrical capacitor 1 according to the embodiment. The lithium ion capacitor internal electrode is composed so that the separator 40 through which only the electrolysis solution and ions can pass is inserted between the active material electrodes 22, 31 having at least one layer, and the extraction electrodes 20a, 30a are exposed from the active material electrodes 22, 31, and the extraction electrodes 20a, 30a are connected to a power supply voltage. The active material electrode 31 of the positive electrode side is formed of activated carbon, for example, and the active material electrode 22 of the negative electrode side is formed of Li doped carbon, for example. The extraction electrode 30a of the positive electrode side is formed of aluminum foil, for example, and the extraction electrode 20a of the negative electrode side is formed of copper foil, for example. The separator 40 of which the size is larger (the area is wider) than that of the active material electrodes 22, 31 is used for covering whole of the active material electrodes 22, 31. The electrolysis solution 44 is impregnated in the lithium ion capacitor internal electrode, and the electrolysis solution and ions are moved through the separator 40 at the time of charge and discharge.

### (Lithium Ion Battery Internal Electrode)

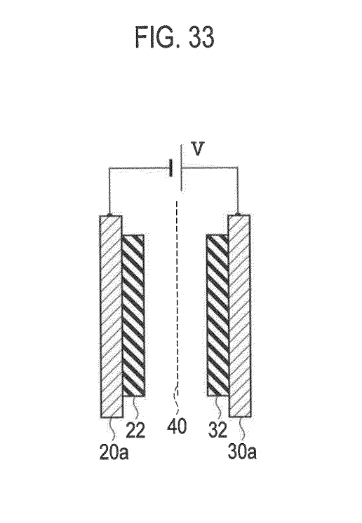

FIG. 33 illustrates a fundamental structure of a lithium ion battery internal electrode, in the electrical capacitor 1 according to the embodiment. The lithium ion battery internal electrode is so that the separator 40 through which only the electrolysis solution and ions can pass is inserted between the active material electrodes 22, 32 having at least one layer, and the extraction electrodes 20a, 30a are exposed from the active material electrodes 22, 32, and the extraction electrodes 20a, 30a are connected to a power supply voltage. The active material electrode 32 of the positive electrode side is formed of LiCoO₂, for example, and the active material electrode 22 of the negative electrode side is formed of Li doped carbon, for example. The extraction electrode 30a of the positive electrode side is formed of aluminum foil, for example, and the extraction electrode 20a of the negative electrode side is formed of copper foil, for example. The separator 40 of which the size is larger (the area is wider) than that of the active material electrodes 22, 32 is used for covering whole of the active material electrodes 22, 32. The electrolysis solution 44 is impregnated in the lithium ion battery internal electrode, and the electrolysis solution and ions are moved through the separator 40 at the time of charge and discharge.

As mentioned above, according to the present invention, there can be provided the electrical capacitor and the electrical capacitor module both of which have low internal electrical resistance and are easy to increase in capacity; and can be provided the fabrication method of such an electrical capacitor, and the fabrication method of such an electrical capacitor module.

### Other Embodiments

The present invention has been described by the embodiment, as a disclosure including associated description and drawings to be construed as illustrative, not restrictive. This disclosure makes clear a variety of alternative embodiments, working examples, and operational techniques for those skilled in the art.

Such being the case, the present invention covers a variety of embodiments, whether described or not.

What is claimed is:

1. An electrical capacitor comprising:
a band-shaped coating foil for negative electrode having a non-coated part of which an edge of one longitudinal side is not coated with an active material;
a band-shaped coating foil for negative electrode having a non-coated part of which an edge of one longitudinal side is not coated with an active material; and
a band-shaped separators through which an electrolysis solution and ions can pass, wherein
the coating foil for positive electrode and the coating foil for negative electrode are flatly wound via the separators so that the non-coated part in the side of the coating foil for positive electrode and the non-coated part in the side of the coating foil for negative electrode are exposed in opposite sides to each other, and the electrode group of the non-coated parts exposed to both sides are bonded.

2. The electrical capacitor according to claim 1, wherein the electrode group of the non-coated parts is bonded with an electrode tab.

3. The electrical capacitor according to claim 2, wherein the length of the bonded part to which the electrode tab is bonded is equal to or greater than 50% of the length of the electrode group of the non-coated parts.

4. The electrical capacitor according to claim 1, wherein the electrode group of the non-coated parts may be bonded with ultrasonic welding or caulking.

5. The electrical capacitor according to claim 4, wherein the non-coated parts of the electrode group is subjected to the ultrasonic welding by pressing a welding head against the non-coated parts once.

6. The electrical capacitor according to claim 4, wherein the non-coated parts of the electrode group is subjected to the ultrasonic welding by pressing the welding head against the non-coated parts several times.

7. The electrical capacitor according to claim 2, wherein the electrode group in which the electrode tabs are bonded thereto is covered with a laminate sheet.

8. The electrical capacitor according to claim 7, wherein pin-shaped lead terminals are respectively connected to the electrode tabs, and the lead terminals are projected to the outside of the laminate sheet.

9. The electrical capacitor according to claim 8, wherein boundary portions between an edge part of the laminate sheet and the respective lead terminals are fixed with resin.

10. The electrical capacitor according to claim 1, wherein the electrical capacitor is an electric double layer capacitor.

11. The electrical capacitor according to claim 1, wherein the electrical capacitor is a lithium ion capacitor.

12. The electrical capacitor according to claim 1, wherein the electrical capacitor is a lithium ion battery.

13. An electrical capacitor module comprising the electrical capacitor according to claim 1, wherein
the electrode group of the non-coated parts is bonded with an electrode tab, the electrode group in which the electrode tabs are bonded thereto is covered with a laminate sheet, pin-shaped lead terminals are respectively connected to the electrode tabs, and the lead terminal are projected to the outside of the laminate sheet, wherein
the electrical capacitor is housed in a box-type case, and the electrode tabs or the lead terminals is connected to the PCB substrate.

14. The electrical capacitor module according to claim 13, wherein a plurality of the electrical capacitors are connected thereto in series, in parallel, or in series parallel.

15. The electrical capacitor module according to claim 14, comprising:
a voltage balance control circuit mounted on the PCB substrate, the voltage balance control circuit configured to control a voltage balance.

16. The electrical capacitor module according to claim 15, wherein
the plurality of the electrical capacitors are housed in a box-type case, and
the respective PCB substrate on which the respective voltage balance control circuit are mounted are provided for the respective electrical capacitors.

17. A fabrication method of an electrical capacitor comprising:
coating an active material other than an edge of one longitudinal side of a band-shaped coating foil for positive electrode;
coating the active material other than an edge of one longitudinal side of a band-shaped coating foil for negative electrode;
laminating the coating foil for positive electrode and the coating foil for negative electrode via separators so that a non-coated part in the side of the coating foil for positive electrode and a non-coated part in the side of the coating foil for negative electrode are exposed in opposite sides to each other;
flatly winding a laminated electrode group; and
bonding the electrode group of the non-coated parts wound to be exposed to both sides.

18. The fabrication method of the electrical capacitor according to claim 17, wherein the electrode group of the non-coated parts is bonded with an electrode tab.

19. The fabrication method of the electrical capacitor according to claim 18, wherein the length of the bonded parts to which the electrode tab is bonded is equal to or greater than 50% of the length of the electrode group of the non-coated parts.

20. The fabrication method of the electrical capacitor according to claim 17, wherein the electrode group of the non-coated parts may be bonded with ultrasonic welding or caulking.

21. The fabrication method of the electrical capacitor according to claim 20, wherein the non-coated parts of the electrode group is subjected to the ultrasonic welding by pressing a welding head against the non-coated parts once.

22. The fabrication method of the electrical capacitor according to claim 20, wherein the non-coated parts of the electrode group is subjected to the ultrasonic welding by pressing the welding head against the non-coated parts several times.

23. The fabrication method of the electrical capacitor according to claim 18, wherein the electrode group in which the electrode tabs are bonded thereto is covered with a laminate sheet.

24. The fabrication method of the electrical capacitor according to claim 23, wherein pin-shaped lead terminals are respectively connected to the electrode tabs, and the lead terminals are projected to the outside of the laminate sheet.

25. The fabrication method of the electrical capacitor according to claim 24, wherein boundary portions between an edge part of the laminate sheet and the respective lead terminals are fixed with resin.

26. The fabrication method of the electrical capacitor according to claim 17, wherein the electrical capacitor is an electric double layer capacitor.

27. The fabrication method of the electrical capacitor according to claim 17, wherein the electrical capacitor is a lithium ion capacitor.

28. The fabrication method of the electrical capacitor according to claim 17, wherein the electrical capacitor is a lithium ion battery.

29. A fabrication method of an electrical capacitor module comprising an electrical capacitor, the electrical capacitor fabricated by the fabrication method of the electrical capacitor according to claim 17, wherein
the electrode group of the non-coated parts is bonded with an electrode tab, the electrode group in which the electrode tabs are bonded thereto is covered with a laminate sheet, pin-shaped lead terminals are respectively connected to the electrode tabs, and the lead terminal are projected to the outside of the laminate sheet, wherein
the electrical capacitor is housed in a box-type case, and the electrode tabs or the lead terminals is connected to the PCB substrate.

30. The fabrication method of the electrical capacitor module according to claim 29, wherein a plurality of the electrical capacitors are connected thereto in series, in parallel, or in series parallel.

31. The fabrication method of the electrical capacitor module according to claim 30, wherein a voltage balance control circuit is mounted on the PCB substrate, the voltage balance control circuit is configured to control a voltage balance.

32. The fabrication method of the electrical capacitor module according to claim 31, wherein the respective PCB substrate on which the respective voltage balance control circuit are mounted are provided for the respective electrical capacitors.
